(19) United States
(12) Patent Application Publication
(10) Pub. No.: US 2026/0336130 A1
(43) Pub. Date: Oct. 29, 2026

(54) MODULAR ROBOTIC PLATFORM AND ROBOT COMPRISING SAID PLATFORM

(71) Applicant: ADDRESS ROBOTICS LIMITED, UK, London (GB)

(72) Inventors: Andrew James SHAW, Whiltshire (GB); Giuseppe MONTANO, London (GB); Vilas Kumar CHITRAKARAN, Aylesbury (GB)

(73) Assignee: ADDRESS ROBOTICS LIMITED, UK, London (GB)

(21) Appl. No.: 19/187,336

(22) Filed: Apr. 23, 2025

(51) Int. Cl. B25J 11/00; B25J 5/00; B25J 9/10; B25J 15/04; B62D 57/032

(52) U.S. Cl. CPC B25J 11/005; B25J 5/00; B25J 9/103; B25J 15/04; B62D 57/032

(57) ABSTRACT

A modular robotic platform comprising a rotatable central body section and two lateral body sections, each configured with a structural interface for attaching mobility components. The platform features a non-backdrivable rotational joint with optional roller bearing cam or worm drive mechanisms, allowing pitch articulation and cable routing through a hollow core. The platform supports interchangeable payloads, modular arms, and tool systems for task-specific reconfiguration in construction, inspection, and logistics environments.

### FIELD OF THE INVENTION

The present invention relates to modular robotic systems and, more particularly, to robotic platforms comprising a multi-section modular main body that supports the integration of diverse mobility configurations and functional payloads. Specifically, the invention is directed toward reconfigurable robots capable of performing task-specific operations in dynamic, unstructured, or industrial environments.

In preferred embodiments, the robotic platform includes a three-part segmented body structure that enhances structural flexibility and internal spatial distribution, with at least one mobility subsystem-such as legged (quadruped), tracked, or wheeled bases-attached to its lateral body segments. These mobility systems enable the robot to traverse a wide range of terrains, including stairs, cluttered environments, or smooth industrial floors, depending on the use case.

The invention is applicable across various sectors requiring automated task execution in physically complex settings. While the robotic platform is particularly suited for building and construction environments-where it may perform functions such as fastening, painting, drilling, surface finishing, and payload transport it is equally adaptable to other industrial domains. These include: logistics and warehouse automation, for material handling, tool transport, and remote inspection; infrastructure inspection and maintenance, including pipeline servicing, facility diagnostics, or high-reach operations; defense and security, including reconnaissance, transport, and situational response in rugged terrain; agriculture, for automated fieldwork, crop care, or inspection tasks across uneven landscapes; energy and utilities, such as servicing of power installations, wind turbines, or substations in remote areas; research and disaster response, where reconfigurable tools and versatile locomotion are essential. The platform offers a scalable, adaptive robotic solution with broad applicability in both civilian and specialized technical fields.

### BACKGROUND OF THE INVENTION

Autonomous and semi-autonomous robotic systems are increasingly used in industries such as construction, logistics, defense, and infrastructure maintenance. These systems typically perform narrowly defined tasks-ranging from bricklaying to painting or inspection-and are often built around monolithic, single-purpose platforms. While valuable in specific workflows, these platforms lack the adaptability, modularity, and operational reach necessary for dynamic, multi-tasking environments like modern construction sites.

For example, U.S. Pat. No. 8,965,571 B2 discloses a semi-automated masonry robot designed to assist human workers in laying bricks and applying mortar. While the invention increases efficiency in bricklaying, it is constrained to a fixed-function architecture. The robotic system cannot switch between tasks, adapt its mechanical configuration, or autonomously relocate across different floor levels of a construction site. Additionally, the platform lacks provisions for reconfigurable payloads or multi-tool integration.

One major limitation of current robotic systems-particularly those used in the construction and field service industries-is their lack of modularity. The vast majority of existing platforms are monolithic in design, with fixed structural configurations that do not allow for reconfiguration or integration of alternative payloads. Each robot is generally optimized for a single function, such as painting, drilling, or transporting materials. As a result, deploying multiple robots is often required to cover even a modest range of tasks, significantly increasing operational costs, maintenance complexity, and training requirements.

Unlike conventional monolithic quadruped designs, the present invention provides a three-part segmented body architecture, comprising a central body section and two lateral body sections, each mechanically and kinematically decoupled via a dedicated rotational joint. This segmentation supports independent movement and load balancing between modules, enabling task-specific configuration and dynamic pitch control-a feature absent from all known prior-art systems. These systems lack internal segment articulation, restricting their ability to adapt orientation dynamically during complex tool use or terrain transitions.

Another major drawback in the prior art is limited terrain adaptability. Many task-specific robots operate only on flat, prepared surfaces and are not capable of navigating cluttered, multi-level environments such as active construction sites. Although quadruped robots have emerged as promising platforms for uneven terrain traversal, their design remains constrained by a centralized, rigid body architecture. This monolithic approach restricts the placement of internal components, limits mechanical flexibility, and impairs dynamic control-particularly when interacting with variable loads or performing high-reach operations.

### SUMMARY OF THE INVENTION

The invention provides a modular robotic platform that addresses the shortcomings of monolithic robotic systems through a segmented structure allowing for high configurability, terrain adaptability, and task-specific extension. Central to the platform is a rotatable coupling between a central body section and two lateral body sections, enabled by a non-backdrivable joint that ensures both mechanical stability and energy efficiency. The modularity extends to interchangeable payload interfaces and mobility configurations, enabling rapid adaptation to construction, inspection, logistics, or defense applications.

The invention provides a modular robotic platform comprising: at least one central body section configured to house control systems; and two lateral body sections positioned on opposing sides of the central body section or central body sections; wherein each lateral body section is configured to provide a structural interface for coupling to a mobility component; and wherein at least one central body section is rotatably coupled to the two lateral body sections, allowing relative rotational movement between the central body section and the lateral body sections. In some embodiments, the modular robotic platform further comprising a rotational joint coupling the central body section to the two lateral body sections. In some embodiments, the rotational joint comprises a roller bearing cam mechanism. In some embodiments, the rotational joint is non-backdrivable. In some embodiments, the rotational joint comprises a worm drive. In some embodiments, the rotational joint is configured to permit at least 180 degrees of relative rotational movement between the central body section and the lateral body sections. In some embodiments, the rotational joint comprises a hollow central portion configured for internal routing of cables or conduits. In some embodiments, at least one of the lateral body sections is configured to house a battery. In some embodiments, the central body section is further configured to provide a structural interface for mounting a payload module. In some embodiments, the central body section and the two lateral body sections are fabricated from a high-strength aluminum alloy. In some embodiments, the modular robotic platform further comprises a rotational joint coupling the central body section to the two lateral body sections, and wherein the rotational joint is non-backdrivable.

The invention provides a robot comprising: a modular robotic platform comprising: at least one central body section configured to house control systems; two lateral body sections positioned on opposing sides of the central body section or central body sections; and wherein at least one central body section is rotatably coupled to the two lateral body sections, allowing relative rotational movement between the central body section and the lateral body sections; and at least two mobility components, wherein at least one mobility component is mounted to one of the lateral body sections and at least one mobility component is mounted to the other lateral body section. In some embodiments, the rotational joint comprises a roller bearing cam mechanism. In some embodiments, the robot comprises four legs, wherein two legs are mounted to one of the lateral body sections and two legs are mounted to the other lateral body section. In some embodiments, at least two legs are identical in design. In some embodiments, each of the at least two legs comprises at least one joint configured for continuous rotation beyond 360 degrees. In some embodiments, the robot comprises at least one robotic arm coupled to the modular robotic platform. In some embodiments, the robot comprises at least one interchangeable tool configured to be coupled to the at least one robotic arm, wherein the tool is adapted for a construction task.

The invention provides a rotational joint assembly for coupling a central body section to lateral body sections of a modular robotic platform, the assembly comprising: a drive mechanism selected from the group consisting of a worm drive, a roller bearing cam mechanism, and combinations thereof, configured to provide relative rotation between the central body section and the lateral body sections; a non-backdrivable configuration inherent to or integrated with the drive mechanism, preventing unintentional relative rotation under load; and a hollow passage extending through the assembly configured for routing connections. In some embodiments, the drive mechanism comprises preloaded components configured to eliminate backlash during relative rotation.

### BRIEF DESCRIPTION OF THE DRAWINGS

FIG. 1 is a perspective view of the modular robotic platform, illustrating the central body section (10), the lateral body sections (11), and the rotational joint assembly (20).

FIG. 2 is a perspective view of a robot comprising the modular robotic platform with one central body section (10), two lateral body sections (11), and two mobility components (30), wherein the central body section is rotated at a 90-degree angle relative to the lateral body sections.

FIG. 3 and FIG. 4 are detailed views of the rotational joint assembly (20), showing the worm (21) and the hollow central cam section (22).

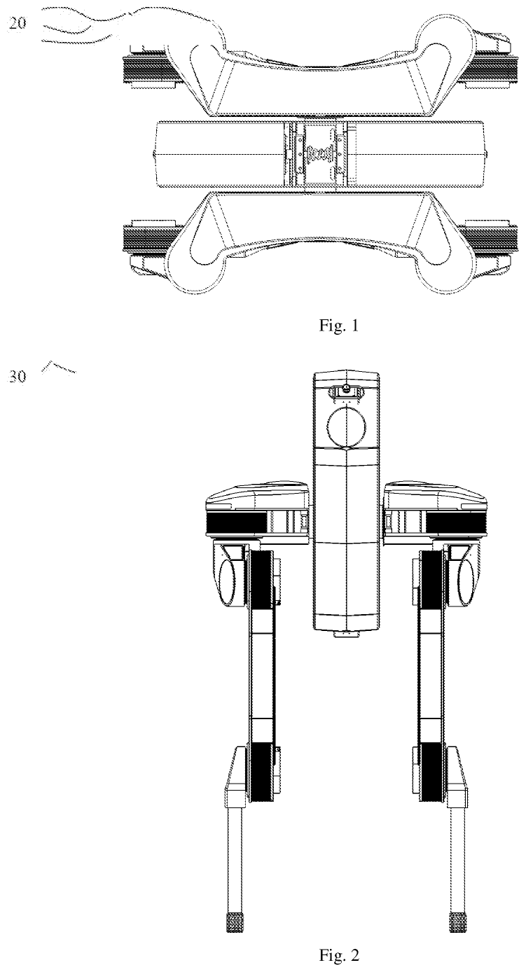

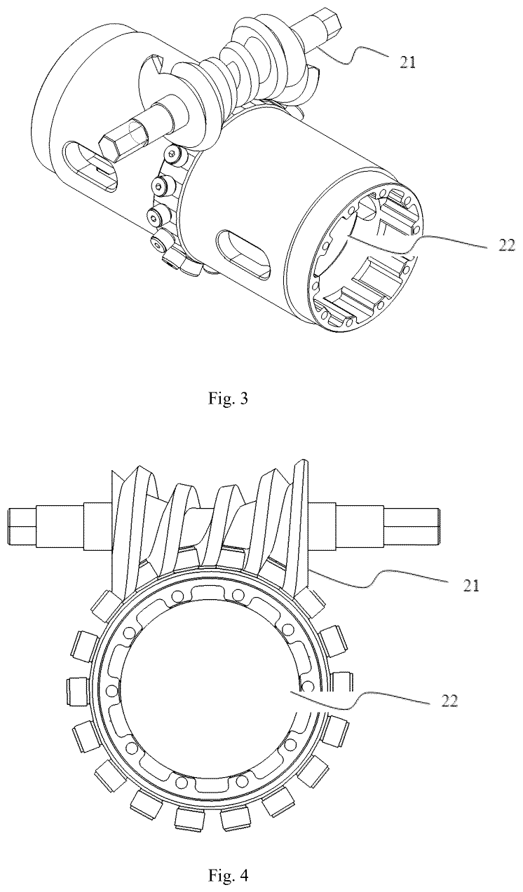

### DETAILED DESCRIPTION OF THE INVENTION

The present invention relates generally to modular robotic systems and, more specifically, to a modular robotic platform, which serves as the main structural body for a robot, and a robot incorporating said platform. The platform is suitable for various applications including construction, logistics, and inspection and features a unique segmented body design offering enhanced flexibility and functionality compared to traditional monolithic structures.

The invention provides a modular robotic platform comprising a central body section and two lateral body sections. Collectively, these sections form the core structure or body of the robot.

The central body section is configured to house essential components, such as control systems, computational hardware, and power distribution systems. These integrated systems are responsible for processing sensor data, executing navigation and manipulation algorithms, managing power flow, and coordinating overall robot behavior. In some embodiments, the central body section further comprises interfaces for sensor fusion systems, inertial measurement units (IMUs), or machine vision cameras. These systems may be used for terrain mapping, path planning, or real-time payload stabilization.

Positioned on opposing sides of the central body section are the two lateral body sections. Each lateral body section is configured to provide a structural interface. This interface is designed for coupling to a mobility component, enabling the platform to be integrated into various mobile robotic systems, such as legged robots, wheeled robots, or tracked robots.

As used herein, “structural interface” refers to a mechanical coupling region configured to support the transfer of operational loads between the platform and attached components, including mounting plates, flanges, sockets, or quick-release mechanisms, optionally with embedded connectors for power and signal lines.

In some embodiments, this structural interface may comprise standardized mounting plates with defined bolt patterns suitable for attaching leg actuators or wheel assemblies, or alternatively, may incorporate a quick-release mechanism for rapid reconfiguration.

A key feature of the platform is that the central body section is rotatably coupled to the two lateral body sections. This coupling allows relative rotational movement between the central body section and the lateral body sections, providing an additional degree of freedom, for instance, for dynamic pitch control of any payloads attached to the central section.

In some embodiments, dynamic pitch control is achieved via an actuator housed within the central body section-preferably a high-torque servo motor integrated with a planetary gearbox. This actuator drives the worm gear coupled concentrically to the cam profile, rotating the central chassis relative to the lateral body sections. This setup provides continuous pitch modulation of attached payloads (e.g., robotic arms) over a typical range of ±90°, with holding torque exceeding [insert torque spec from your design, e.g., 80 Nm], sufficient to stabilize the platform under full payload deployment.

In some embodiments, the platform further comprises a dedicated rotational joint that facilitates the coupling and relative movement between the central and lateral body sections. This joint ensures a structurally rigid yet low-friction interface.

In some embodiments, the rotational joint comprises a roller bearing cam mechanism. This mechanism can provide smooth, controlled movement and precise motion deceleration.

In some embodiments, the rotational joint is non-backdrivable. This feature prevents unintentional movement under load, enhances stability, and can significantly reduce energy consumption, particularly when holding static positions or carrying payloads. In some embodiments, the non-backdrivability is achieved through the inherent properties of the worm drive component, potentially in combination with preloading techniques applied to the roller bearing cam mechanism to eliminate backlash.

In some embodiments, the rotational joint comprises a worm drive. Such a drive, potentially used in conjunction with the roller cam gear, can form part of the non-backdrivable mechanism and achieve efficient speed reduction. Mechanisms like a roller gear cam and worm with preloaded follower rollers can eliminate backlash, ensuring high positional accuracy.

In some embodiments, the rotational joint comprises a worm-driven roller bearing cam system engineered for non-backdrivability and zero-backlash operation. The mechanism utilizes preloaded follower rollers to maintain constant contact with the cam profile, achieving sub-degree-level positional accuracy critical for high-load tool use, such as overhead drilling or robotic plastering at height. Unlike standard worm or harmonic drives, which suffer from power-hold inefficiencies or drive-backlash, this joint eliminates both, allowing static pose holding without power and precise repositioning under external load. Additionally, the hollow central cam channel enables safe, strain-relieved cable routing, avoiding torsional windup through a layered conduit with flexible sheath clamping at each end.

In some embodiments, cable protection through the rotational joint is achieved using a centralized cable duct with internal routing through the hollow worm-cam axis. Cables are enclosed in a flexible protective sheath with strain-relief bushings at the ingress and egress points. These bushings are integrated into the support hubs to prevent load transfer to connectors during joint actuation.

In preferred embodiments, the rotational joint coupling the central body section to the lateral body sections is implemented using a roller bearing cam mechanism, a worm drive, or a combination thereof. This selection provides a number of critical advantages in robotic applications that demand positional stability and energy efficiency.

In particular, worm drives inherently exhibit non-backdrivable characteristics, meaning that external torques acting on the central section-such as those arising from payload weight, environmental forces, or dynamic motions-do not result in unintended movement or drift. Similarly, roller bearing cam mechanisms can be engineered with preloaded follower systems that eliminate backlash and contribute to positional precision under load.

These features significantly reduce the need for active holding torque during static operation. As a result, the system can maintain stable positioning of payloads (e.g., robotic arms or tools) without consuming additional power, which is especially beneficial for battery-powered platforms or tasks requiring prolonged holding, such as drilling or high-reach manipulation.

In contrast, other possible options like harmonic drives offer high precision and compact packaging, they are generally backdrivable under load, particularly when torque exceeds a certain threshold. This would necessitate either continuous power consumption to hold a position, leading to increased thermal and battery strain, or the integration of a mechanical braking system to achieve comparable static stability. Both options introduce design complexity, increased weight, and reduced energy efficiency, which are undesirable in mobile or field-deployed robotic systems.

Therefore, the use of roller bearing cam mechanisms and worm drives in the rotational joint enhances mechanical reliability, reduces power consumption, and improves operational safety-making them particularly well-suited for the demanding environments and variable loads encountered in construction, inspection, and other dynamic field applications.

In some embodiments, the rotational joint is configured to permit at least 180 degrees of relative rotational movement between the central body section and the lateral body sections. While the joint architecture might support unlimited rotation, limiting the motion to a specific range like 180 degrees can optimize performance for intended applications while managing mechanical complexity.

In some embodiments, the rotational joint comprises a hollow central portion or passes through a hollow central cam. This hollow structure is configured for the internal routing of cables, conduits, or other necessary connections through the axis of rotation, mitigating issues like torsional windup and potential entanglement during articulation.

In some embodiments, at least one of the lateral body sections is configured as a compartment suitable for housing components such as a battery or other subsystems. This distributes weight and frees space within the central section.

In some embodiments, the central body section is further configured to provide a structural interface for mounting a payload module. This allows various task-specific modules, such as robotic arms or sensor packages, to be attached to the platform.

In some embodiments, the central body section and the two lateral body sections (constituting the platform) are fabricated from a high-strength, lightweight material, such as a high-strength aluminum alloy. This choice of material helps to maximize rigidity while minimizing overall system mass.

In some embodiments, the three primary body sections are joined via precision-machined hubs secured using a hybrid quick-connect and bolt-on mechanism. This configuration enables rapid disassembly for transport or maintenance, while maintaining rigid load-bearing capability during operation. The connection includes alignment pins, locking latches, and anti-rotation features, allowing tool-less or single-tool field service operations.

The structural design of the disclosed modular robotic platform provides particular advantages when applied within construction, manufacturing, and building industries. These advantages derive directly from the platform's core architectural features, enhancing its suitability for the demanding and varied nature of such environments.

Specifically, the platform's segmented construction, comprising at least one central body section and two lateral body sections, facilitates significant adaptability. The lateral body sections, by providing dedicated structural interfaces, allow the platform core to be readily integrated with diverse mobility systems-including legged, wheeled, or tracked systems-thereby tailoring the robot's locomotion capabilities to specific site conditions ranging from uneven terrain to smooth factory floors. This modularity also enables optimized placement of subsystems, with the central section housing control and processing units and serving as a payload interface, while lateral sections can accommodate power sources or drive components.

Furthermore, the rotatable coupling between the central body section and the lateral body sections introduces an advantageous additional degree of freedom at the platform level. This relative rotation enables dynamic orientation control for payloads mounted on the central section, allowing improved reach and maneuverability for tasks in complex or constrained workspaces typical of construction sites or assembly lines, without requiring repositioning of the entire robotic base (i.e., the complete mobile system including the platform and mobility components).

The characteristics of the rotational joint itself contribute significantly to operational effectiveness. Embodiments featuring a non-backdrivable joint mechanism provide crucial stability, preventing unintentional movement of the central section and any attached payload, even under external forces or gravity. This feature is particularly beneficial for tasks requiring precision and force application, such as drilling, fastening, lifting, or steady holding of components, enhancing both safety and task accuracy. Moreover, non-backdrivability can contribute to energy efficiency by reducing the power required to maintain a static payload orientation. The use of precision mechanisms, such as roller bearing cams or worm drives, potentially configured to minimize or eliminate backlash, further enhances the accuracy of payload positioning.

The provision of a structural interface on the central body section for mounting payload modules underscores the platform's inherent design for versatility, enabling it to function as a multi-task capable base. Additionally, the fabrication of platform components from high-strength, lightweight materials, such as aluminum alloys, optimizes the payload-to-weight ratio and enhances the dynamic performance and energy efficiency of the resulting robotic system.

Collectively, these design features of the modular robotic platform—its segmented structure, adaptable interfaces, rotatable coupling with potentially non-backdrivable characteristics, dedicated payload integration, and optimized material usage—render it an exceptionally effective foundation (or main body structure) for robotic systems aimed at automating tasks in the construction, manufacturing, and building sectors.

The invention also provides a legged robot incorporating the modular robotic platform described above. The robot comprises the platform (including the central body section rotatably coupled to the two lateral body sections) and at least two legs. The legs provide mobility for the robot. The configuration requires that the at least two legs comprise at least one leg mounted to one of the lateral body sections and at least one leg mounted to the other lateral body section. In other words, each leg is mounted to at least one of the lateral body sections, such that at least one leg is mounted to each lateral body section.

In preferred embodiments, each leg is mounted to exactly one of the lateral body sections. This ensures distributed support and allows for locomotion.

In some embodiments of the legged robot, the modular robotic platform includes the rotational joint coupling the central and lateral sections, wherein the joint is non-backdrivable. This enhances the stability of the legged robot during movement and task execution.

In some embodiments where the rotational joint is present and non-backdrivable, the joint comprises a roller bearing cam mechanism.

In some embodiments, the legged robot comprises four legs. In such a quadruped configuration, typically two legs are mounted to one of the lateral body sections, and two legs are mounted to the other lateral body section, providing significant stability and terrain adaptability.

In some embodiments, the legs of the robot are identical in design. Using identical legs can streamline manufacturing, reduce production costs, and simplify maintenance and repair procedures.

In some embodiments, each leg comprises at least one joint configured for continuous rotation beyond 360 degrees. This extended kinematic range in joints, such as hip or distal limb segments, can enhance the robot's dexterity and ability to navigate complex environments or perform intricate maneuvers. Legs may incorporate motors with integrated high-load bearings directly coupled to subsequent stages for efficient torque transmission.

In some embodiments, the robot further comprises at least one robotic arm coupled to the modular robotic platform. The arm allows the robot to interact with its environment, manipulate objects, and perform tasks. The arm can be mounted, for example, to the interface on the central body section.

In some embodiments, at least one robotic arm is interchangeable. The robot may feature a standardized mechanical and electrical interface allowing different types of arms or other payload modules to be attached and detached, potentially autonomously. This standardized interface ensures reliable transmission of power, control signals (e.g., using common industrial robotics communication protocols like EtherCAT or CANopen), and data telemetry between the platform and the attached module. The arm can be selected for example from the group consisting of a dexterous arm and a telescopic arm or others. A dexterous arm may offer high manipulation capability within a certain reach (e.g., 1.5 meters) and payload capacity (e.g., 25 kg), potentially with an optimized lightweight yet strong structure. A telescopic arm can significantly extend the robot's vertical reach (e.g., up to 4 meters) for tasks involving elevated structures. In some embodiments, several arms could be installed.

In some embodiments where the robot includes a robotic arm, it further comprises at least one interchangeable tool configured to be coupled to the arm. These tools are end-effectors that allow the robot to perform specific operations. The tools can utilize a standardized interface, compatible with different arms, for easy and potentially autonomous exchange. The robot might carry multiple tools in a dedicated module.

In some embodiments, the interchangeable tool is adapted for a construction task. The construction task can be selected from the group consisting of drilling, fastening (e.g., screw driving, bolting), painting, plastering, and sanding or others. For example, a drilling tool may perform drilling operations, a fastening tool may insert/remove screws or bolts to specific depths or torques, a painting tool may apply coatings, a plastering tool may apply plaster, and a sanding tool may prepare or finish surfaces. Each tool incorporates necessary actuation mechanisms and may be designed for autonomous handling by the robot.

While the primary embodiment described herein focuses on a legged robot configuration, particularly suited for navigating complex terrains like construction sites, the modular nature of the robotic platform allows for significant variation and adaptation to different mobility systems and application domains.

The structural interfaces on the lateral body sections are designed for adaptability. Instead of legs, these interfaces can be readily configured to couple with other types of mobility components.

For example, wheeled base: the platform could be integrated with a wheeled chassis, comprising two or more wheels attached to each lateral section, potentially via suspension systems. This configuration might be advantageous for applications requiring faster movement over relatively flat surfaces, such as in logistics warehouses or factory floors.

Alternatively, the lateral sections could interface with tracked mobility units. A tracked configuration would offer excellent traction and stability on soft or uneven ground, potentially suitable for agricultural, outdoor inspection, or certain defense applications.

In both wheeled and tracked embodiments, the core modular platform comprising the central and lateral sections, along with the rotational joint, retains its function, providing payload mounting, housing for control systems, and the added degree of freedom for payload orientation.

The versatility derived from the modular platform, interchangeable arms, and diverse tooling makes the robot suitable for a wide range of applications beyond construction. Potential application domains include, but are not limited to: logistics (automating material handling, transport, loading, and unloading in warehouses, distribution centers, or ports), defense, inspection and maintenance (conducting inspections of infrastructure like bridges, pipelines, power plants, etc, large machinery, or hazardous environments, potentially using specialized sensor payloads or tools), agriculture (assisting with tasks such as planting, monitoring, harvesting, or targeted spraying in fields or greenhouses), emergency response (navigating disaster sites for search and rescue operations or hazard assessment).

In each application domain, the specific configuration of mobility components (legs, wheels, tracks), payload modules (arms, sensors, specialized equipment), and end-effector tools can be tailored to meet the operational requirements, leveraging the inherent modularity and adaptability of the core robotic platform.

The disclosed modular robotic platform and the robot incorporating it are particularly well-suited for tasks within the construction, manufacturing, and building industries due to a unique combination of adaptability, mobility, stability, and precision, stemming directly from its core design features. The combination of a modular, multi-section body with a rotatable, potentially non-backdrivable coupling, integrated with adaptable mobility components (like legs) and interchangeable, task-specific payloads (arms and tools), provides a robotic system uniquely capable of addressing the diverse and demanding requirements of modern construction, manufacturing, and building automation.

The terms and definitions used in this application are provided solely for the purpose of describing the invention and facilitating its understanding. They should not be interpreted in a manner that limits the scope of the claims or restricts the applicant's rights.

The embodiments and examples disclosed in this application are illustrative and non-limiting. Variations, modifications, and equivalents that fall within the spirit and scope of the invention, as defined by the appended claims, are intended to be encompassed therein.

The use of singular terms, such as “a,” “an,” and “the,” should also be interpreted to include plural forms unless explicitly stated otherwise. Similarly, the use of specific terms should not be construed as excluding equivalents that serve the same function or achieve the same result.

The scope of the invention is defined by the claims, and the description should not be used to limit the interpretation of these claims.

1. A modular robotic platform comprising:
at least one central body section configured to house control systems; and
two lateral body sections positioned on opposing sides of the central body section or central body sections;
wherein the at least one central body section and the two lateral body sections collectively form a segmented body structure of the platform;
wherein each lateral body section is configured to provide a structural interface for coupling to a mobility component; and
wherein the at least one central body section is rotatably coupled to each of the two lateral body sections about a single common axis of rotation shared by the two lateral body sections, the at least one central body section being interposed between the two lateral body sections along said single common axis of rotation, such that the at least one central body section is rotatable relative to both of the two lateral body sections about said single common axis of rotation.

2. A robot comprising:
a modular robotic platform comprising:
at least one central body section configured to house control systems;
two lateral body sections positioned on opposing sides of the central body section or central body sections; and
wherein the at least one central body section and the two lateral body sections collectively form a segmented body structure of the platform; and
wherein the at least one central body section is rotatably coupled to each of the two lateral body sections about a single common axis of rotation shared by the two lateral body sections, the at least one central body section being interposed between the two lateral body sections along said single common axis of rotation, such that the at least one central body section is rotatable relative to both of the two lateral body sections about said single common axis of rotation allowing relative rotational movement between the central body section and the lateral body sections; and
at least two mobility components, wherein at least one mobility component is mounted to one of the lateral body sections and at least one mobility component is mounted to the other lateral body section.

3. A rotational joint assembly for coupling a central body section to lateral body sections of a modular robotic platform, wherein the central body section and the lateral body sections collectively form a segmented body structure of the platform, the assembly comprising:
a drive mechanism selected from the group consisting of a worm drive, a roller bearing cam mechanism, and combinations thereof, configured to provide relative rotation between the central body section and the lateral body sections about a single common axis of rotation shared by the lateral body sections, the central body section being interposed between the lateral body sections along said single common axis of rotation;
a non-backdrivable configuration inherent to or integrated with the drive mechanism, preventing unintentional relative rotation under load; and
a hollow passage extending through the assembly configured for routing connections.

4. The modular robotic platform of claim 1, further comprising a rotational joint providing said rotatable coupling of the at least one central body section to each of the two lateral body sections about said single common axis of rotation.

5. The modular robotic platform of claim 4, wherein the rotational joint comprises a roller bearing cam mechanism.

6. The modular robotic platform of claim 4, wherein the rotational joint is non-backdrivable.

7. The modular robotic platform of claim 4, wherein the rotational joint comprises a worm drive.

8. The modular robotic platform of claim 4, wherein the rotational joint is configured to permit at least 180 degrees of relative rotational movement between the central body section and the lateral body sections.

9. The modular robotic platform of claim 4, wherein the rotational joint comprises a hollow central portion configured for internal routing of cables or conduits.

10. The modular robotic platform of claim 1, wherein at least one of the lateral body sections is configured to house a battery.

11. The modular robotic platform of claim 1, wherein the central body section is further configured to provide a structural interface for mounting a payload module.

12. The modular robotic platform of claim 1, wherein the central body section and the two lateral body sections are fabricated from a high-strength aluminum alloy.

13. The robot of claim 2, wherein the modular robotic platform further comprises a rotational joint providing said rotatable coupling of the at least one central body section to each of the two lateral body sections about said single common axis of rotation, and wherein the rotational joint is non-backdrivable.

14. The robot of claim 13, wherein the rotational joint comprises a roller bearing cam mechanism.

15. The robot of claim 2, comprising four legs, wherein two legs are mounted to one of the lateral body sections and two legs are mounted to the other lateral body section.

16. The robot of claim 2, wherein the at least two mobility components are identical in design.

17. The robot of claim 2, wherein the at least two mobility components comprise at least two legs, and wherein each of the at least two legs comprises at least one joint configured for continuous rotation beyond 360 degrees.

18. The robot of claim 2, further comprising at least one robotic arm coupled to the modular robotic platform.

19. The robot of claim 18, further comprising at least one interchangeable tool configured to be coupled to the at least one robotic arm, wherein the tool is adapted for a construction task.

20. The rotational joint assembly of claim 3, wherein the drive mechanism comprises preloaded components configured to eliminate backlash during relative rotation.
